(19) United States
(12) Patent Application Publication
(10) Pub. No.: US 2023/0258961 A1
(43) Pub. Date: Aug. 17, 2023

(54) Disposable Prescription Stickers for Eyewear and Method of Use

(71) Applicant: Shawn Cannon Medeiros, Honaunau, HI (US)

(72) Inventor: Shawn Cannon Medeiros, Honaunau, HI (US)

(21) Appl. No.: 17/846,480

(22) Filed: Jun. 22, 2022

Related U.S. Application Data
(60) Provisional application No. 63/310,310, filed on Feb. 15, 2022.

(51) Int. Cl. G02C 7/08; G02B 1/14; G02C 7/10

(52) U.S. Cl. CPC G02C 7/086; G02B 1/14; G02C 7/108

(57) ABSTRACT

The present invention relates to a vision prescription sticker and a method for using the sticker to convert eyewear into prescription eyeglasses. The prescription sticker is adhered to the inside surface of a lens of conventional eyewear for correcting vision defects. The sticker has a corrective optical film and an adhesive layer embodied as a one-piece disposable and waterproof structure. The sticker comes in different shapes, sizes and corrective power and can be used to convert snorkel masks, ski goggles and protective eyewear into prescription eyewear.

### CROSS-REFERENCE TO RELATED APPLICATION

The present application claims priority to, and the benefit of, U.S. Provisional Application No. 63/310,310, which was filed on Feb. 15, 2022, and is incorporated herein by reference in its entirety.

### FIELD OF THE INVENTION

The present invention relates generally to the field of accessories for eyeglasses and prescription lenses. More specifically, the present invention relates to a novel disposable and transparent prescription sticker configured to transform any sunglass or eyewear into prescription eyewear. The sticker has a corrective optical film and is removably adhered to the inside surface of a lens of eyewear such as eyeglasses. The sticker provides the desired prescription power for correcting a vision defect of a wearer of the lens. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, prescription lenses are used by people to correct their vision defects. Prescription lenses are used in spectacles, eyeglasses, monocles, and many times people install prescription lenses in their sunglasses or other eyewear as well. However, prescription sunglasses are expensive, and everybody cannot afford them or cannot afford to have multiple pairs of glasses in the event they wish to have a separate set of eyewear for different events. So, many people while wearing eyeglass, such as sunglasses, cannot see properly and therefore, cannot fully enjoy their surroundings. Similarly, sports and water enthusiasts install prescription lenses in their snorkel masks, sports goggles, binoculars, scopes and the like in order to be able to fully utilize the glasses or other devices. However, eyewear, particularly the frames which support the lenses, is expensive and people cannot completely enjoy their outdoor activities without the use of such expensive eyewear. People desire a device and method which allows individuals to transform their glasses and different types of sports eyewear into prescription eyewear in a cost-effective and convenient manner.

In order to avoid expensive eyewear prescription lenses, many individuals with vision problems use contact lenses. However, contact lenses, at least partially, block oxygen supply to the eyes, may cause dry eyes, irritation, conjunctivitis, diminished corneal reflex and ocular issues. Further, contact lenses are not considered safe during water activities or where wind speed is substantial. People desire a novel way of correcting their vision defects without wearing contact lenses or using expensive lenses.

For conventional sunglasses, googles and other eyewear, it would be most useful to have a temporary and cost-effective solution that can easily and quickly transform eyewear lenses into prescription lenses so users need not have to rely on contact lenses or buy expensive prescription eyewear such as sunglasses and other sports eyewear. The desired solution should also reduce the dependency on the need to seek professional help for maintaining the prescription lenses.

Therefore, there exists a long-felt need in the art for a device and method that can instantly convert lenses of regular glasses or any other eyewear into prescription eyeglass lenses. There is also a long-felt need in the art for a device and method that temporarily converts the glasses into prescription glasses. Additionally, there is a long-felt need in the art for an apparatus that can be easily and removably attached to the lenses of glasses and sports eyeglasses for converting the glasses into prescription lenses. Moreover, there is a long-felt need in the art for an apparatus that eliminates the need for users to purchase expensive prescription glasses. Further, there is a long-felt need in the art for an apparatus that offers a wearer the ability to enjoy outdoor activities without worry or fear of not being able to see their surroundings. Furthermore, there is a long-felt need in the art for an optical corrective product and method that can be used for different vision defects. Finally, there is a long-felt need in the art for an optical corrective system that accommodates any age group and can be removably attached to lenses of any existing eyeglass.

The subject matter disclosed and claimed herein, in one embodiment thereof, comprises a transparent prescription sticker for sunglasses, googles, and other eyewear. The sticker is configured to removably attach to a lens of the eyewear and functions to correct a vision or sight related defect of a wearer of the lens. The prescription sticker has a one-piece construction and further includes a corrective optical film on the front surface and an adhesive material disposed on the rear surface thereof. The optical film has a corrective optical power to refract the light rays passing therethrough. The rear surface is configured to removably adhere to the inside of the lens, and the label or sticker is sized and shaped to fit the dimensions of the inner surface of the eyeglass lens. The sticker or label is shaped and sized to adapt to the dimensions of the lens and is disposable.

In this manner, the prescription sticker of the present invention accomplishes all of the foregoing objectives and provides users with the ability to instantly convert lenses of regular sunglasses and other eyewear into prescription lenses. The sticker or label is removably attached allowing the users to temporarily convert their sunglasses into prescription sunglasses. The sticker or label can be adhered to any lens and eliminates the need to purchase one or more pair of expensive prescription glasses. The sticker or label is easily disposable and removably attached to the lens of an existing eyewear frame for easy use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a transparent prescription sticker or label for glasses. The prescription sticker has a one-piece construction and further includes a corrective optical film on the front surface and an adhesive material disposed on the rear surface. The optical film has a pre-determined or customized corrective optical power to refract the light rays passing therethrough and allows the wearer to see his or her surroundings more clearly. The rear surface is configured to removably adhere to the inside of a lens contained within an eyewear frame, and the sticker or label is sized and shaped to fit to the dimensions of the inner surface of the lens.

In yet another embodiment, the transparent prescription sticker or label is disposable.

In yet another embodiment, the transparent prescription sticker or label is reusable.

In yet another embodiment, the sticker is used for correcting at least one of nearsightedness, farsightedness, astigmatism, and age-related loss of close-up vision.

In yet another embodiment, the prescription sticker or label is made from a biodegradable and flexible polymer or plastic material.

In yet another embodiment, a disposable prescription sticker or label for converting a lens of regular sunglasses, snorkel masks, ski goggles, eyewear, and protective eyewear into a prescription lens is disclosed. The sticker or label includes an adhesive layer protected by a removable or peelable cover. The adhesive layer is configured to adhere to the concave surface of the lens such that a corrective optical layer of the sticker faces the eye of a wearer of the lens and provides the corrective optical power needed to correct vision defects and the wearer is able to see their surrounding environment clearly.

In yet another embodiment, the disposable prescription sticker or label provides UV protection and may be provided with a polarizing film.

In yet another embodiment, a method for converting lenses of eyewear or any types of eyeglasses into prescription lenses is described. The method includes the steps of selecting or creating a pair of prescription stickers or labels having an optical corrective power prescribed for a user and then adhering the selected prescription stickers or labels to the inside surface of the lenses of the eyeglass frames. The light passing through the stickers or labels is refracted before entering the eyes of the wearer.

In yet another embodiment, the method further includes the step of removing the prescription stickers or labels after use and disposing of the labels or stickers.

In yet another embodiment, the method further includes the step of removing a cover of each of the labels or stickers to adhere the stickers or labels to the lenses of the eyeglass.

In yet a further embodiment, the method includes an additional step of setting the size and dimension of the lenses for the stickers or labels to be created.

In yet a still further step, a user is able to select colors of the stickers or labels so as to match the color of the existing lenses.

In a still further step, a wearer is able to create a pair of stickers or labels with each sticker or label of the pair having a different prescription.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the disposable prescription sticker of the present invention in accordance with the disclosed architecture;

FIG. 2A illustrates a side perspective view showing the prescription sticker or label of the present invention being adhered to an inside surface of an eyeglass lens in accordance with the disclosed architecture;

FIG. 2B illustrates a side perspective view of the eyewear having one potential embodiment of a prescription lens installed with one of a colored film, UV or polarizing film in accordance with the disclosed architecture;

FIG. 3A illustrates a perspective view of one potential embodiment of commercial packaging of prescription stickers or labels of the present invention in accordance with the disclosed architecture;

FIG. 3B illustrates a perspective view of another potential embodiment of commercial packaging of prescription stickers or labels of the present invention in accordance with the disclosed architecture;

FIG. 4 illustrates the protective cover for the adhesive layer of the sticker being removed for use with a lens in accordance with the disclosed architecture; and

FIG. 5 illustrates a flow chart showing exemplary steps in using the prescription sticker for correcting a vision defect in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device and method that can instantly convert lenses of regular sunglasses or any other eyewear into prescription eyeglass lenses. There is also a long-felt need in the art for a device and method that temporarily converts the sunglasses into prescription sunglasses. Additionally, there is a long-felt need in the art for an invention that can be easily and removably attached to the lenses of eyewear and sports eyeglasses for converting the eyewear into prescription lenses. Moreover, there is a long-felt need in the art for an apparatus that eliminates the need for users to purchase one or more pairs of expensive prescription sunglasses. Further, there is a long-felt need in the art for an invention that offers a wearer the ability to enjoy outdoor activities without worry or fear of not being able to see their surroundings clearly. Furthermore, there is a long-felt need in the art for an optical corrective apparatus that can be used to correct different vision issues. Finally, there is a long-felt need in the art for an optical corrective apparatus that accommodates any age group and can be removably attached to lenses of any existing eyeglasses.

The present invention, in one exemplary embodiment, is a disposable prescription sticker or label for converting the lenses of regular eyewear, snorkel masks, ski goggles and protective eyewear into prescription lenses. The sticker includes an adhesive layer protected by a removable cover. The adhesive layer is configured to adhere to a concave surface of the lens such that a corrective optical layer of the sticker or label faces the eye of a wearer and the sticker provides the corrective optical power desired by a wearer of the lens.

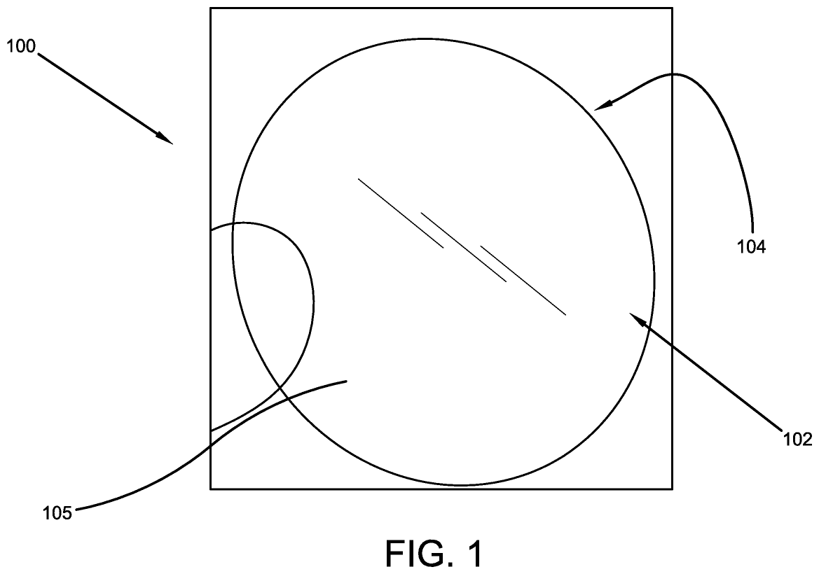

Referring initially to the drawings, FIG. 1 illustrates a perspective view of one potential embodiment of the disposable prescription sticker or label 100 of the present invention in accordance with the disclosed specification. The disposable prescription sticker or label 100 of the present invention is designed as an optically clear and flat sticker or label that is configured to adhere to the inside surface of a lens of any pair of eyeglasses such as a sunglasses. The optically clear film may be PETG Film (Polyethylene Terephthalate Glycol) or other polyethylene film. The sticker or label 100 is designed to convert a pair of regular sunglasses or non-prescription glasses into prescription eyeglasses. The sticker or label 100 has a clear and corrective optical film 102 configured to provide an optical corrective power enabling the sticker 100 to function as a corrective lens. A transparent adhesive material is disposed on the rear surface 104 of the sticker or label 100 allowing the sticker or label 100 to easily adhere to a lens of eyewear without obstructing the vision of a wearer of the eyeglass. The rear surface 104 is protected by a removable protective cover 105 for protecting the adhesive material from any physical damage, deterioration, or contamination. The protective cover 105 may have a silicone coating provided on the side facing the adhesive to allow for the easy removal of the cover, and the protective cover 105 substantially covers the rear surface and the adhesive. The adhesive is an optically clear adhesive and preferably an acrylic based adhesive.

The sticker or label 100 is designed to provide a single corrective power or may be designed to provide two corrective powers allowing people to use their sunglasses, snorkel masks, ski goggles, protective eyewear and other eyewear as prescription glasses. Accordingly, the sticker or label 100 offers a wearer the ability to enjoy all their favorite outdoor activities without worry or fear of not being able to see their surroundings clearly. In the preferred embodiment, the sticker or label 100 has a uniform thickness and comes in different shapes and sizes adapted for lenses of different types of eyewear, sunglasses and other glasses. In addition to providing optical corrective power, the sticker or label 100 may include a coating for providing protection from harmful ultraviolet rays, color or tints to match the color of the original lens, or polarizing material so that the lenses may be used to go from light to dark areas and change from light to dark to provide protection.

The sticker or label 100 is made from a biodegradable and flexible polymer or plastic material. Preferably, the sticker or label 100 has a pre-determined time limit for use and can be disposed of after single use. However, a reusable sticker or label 100 is also contemplated in the present invention. The sticker or label 100 can withstand washing with water, soap, or any eyeglass cleaning solution. The lens sticker or label 100 is thin and can have a thickness of about from 0.005 inches to 0.05 inches.

The sticker 100 is configured to change the focal length of the lenses of the eyeglasses worn by a user, allowing the individual to clearly see their surroundings without any blur. The sticker or label 100 comes in different prescriptions to correct nearsightedness, farsightedness, astigmatism, and age-related loss of close-up vision.

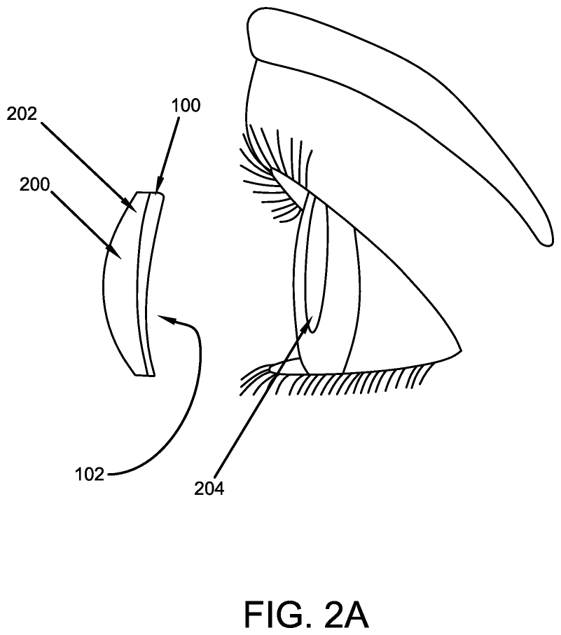

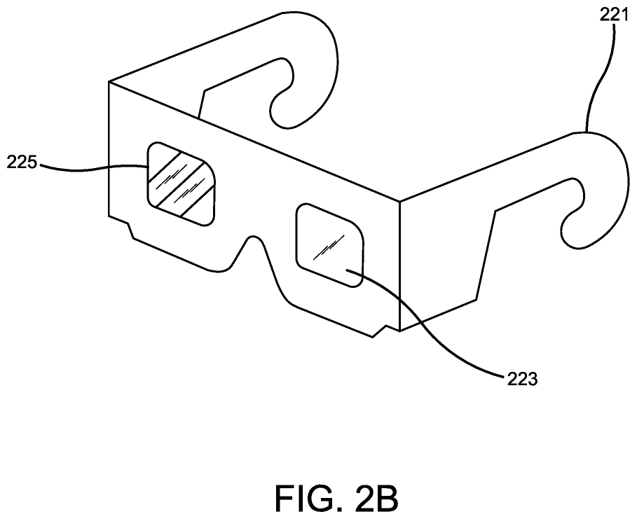

FIG. 2A illustrates a side perspective view showing the prescription sticker 100 of the present invention being adhered to the inside of an eyeglass lens in accordance with the disclosed specification. The rear surface 104 of the sticker 100 has the adhesive material that is used to adhere the label to the inside (concave) surface 202 of the lens 200 such that the corrective optical film 102 faces the eye 204 of a wearer of the lens 200. The lens 200 can be of any conventional eyeglass, sunglass, any sports eyewear and other eyewear enabling the sticker or label 100 to convert any eyeglass or eyewear into a pair of prescription eyeglasses. In the preferred embodiment, the adhesive surface 104 does not permanently stick on the lenses of the sunglasses and can be easily pulled to remove from the lens to be dispose of. The adhesive is one of a repositionable or removable adhesive. Alternatively, the adhesive may be an activatable adhesive, such that the adhesive becomes tacky upon application of heat, moisture, or other activating treatment.

The sticker or label 100 is configured to refract the light rays coming into the eye 204 of a wearer for providing a corrected vision without the need to wear prescription eyeglasses. In one embodiment, when the size of the sticker or label 100 is larger than size of the lens 200, the sticker or label 100 can be cut using scissors, a knife or other cutting implement.

FIG. 2B shows a pair of eyeglasses 221 with a first lens 223 installed in one portion of the frame of the eyeglasses 221 and a second lens 225 having one of a tint, color, UV film, polarizing film or combination thereof disposed on the lens 225. The individual, when adapting the lenses of the present invention to a pair of sunglasses, may elect to color the lenses so that they match the manufacturer's color of the sunglasses so as to not diminish from the trade dress of the branded pair of sunglasses.

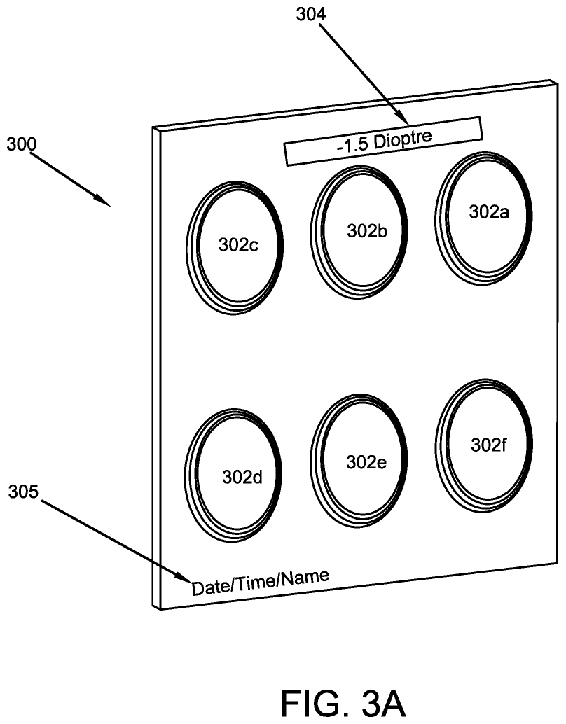

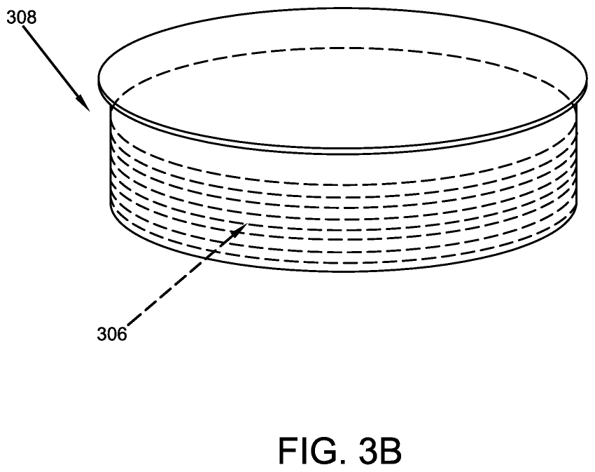

FIG. 3A illustrates a perspective view of one potential embodiment of a commercial packaging of a prescription sticker 100 of the present invention in accordance with the disclosed specification. In the present embodiment, the prescription sticker or label 100 is packaged in a slotted sheet 300 having a plurality of slots 302a-f for securely storing the prescription stickers or labels. An individual sticker or label can be separately accessed by removing a covering of the sheet 300.

The sheet 300 may have an optical correction value label 304 disposed thereon for enabling the users to identify the correction value of the stickers. In the preferred embodiment, all the stickers or labels have a common optical correction value and alternatively, can have different correction values. The sheets having stickers or labels of common prescriptions, can be sold in different sizes at drug stores over the counter or through an online application. For exceptional and complicated vision problems, the stickers or labels 100 can be made based upon a prescription from an individual's optometrist or ophthalmologist. The sheet 300 may also be provided with other indicia 305, such as the date and time the sheet was manufactured as well as the name of the individual for whom the stickers or labels were made for to avoid confusion among other individuals that may be using the same service.

FIG. 3B illustrates a perspective view of another potential embodiment of a commercial packaging of a group of prescription stickers or labels 100 of the present invention in accordance with the disclosed specification. In the present embodiment, the prescriptions stickers or labels are arranged in a stacked configuration 306, such that the adhesive surface with the protective covering of one sticker is placed on the face of the corrective optical film 102 of the other sticker. A slip sheet may also be used between the layers of labels or stickers to prevent the sheets of lenses from sticking together. The stacked stickers or labels can be placed in a box, carton, or package 308 for protecting the stickers or labels from dirt, dust, and damage. A user can take out a single sticker or label from the stack 306 for use by placing a thumb or finger on the top sticker of the stack 306.

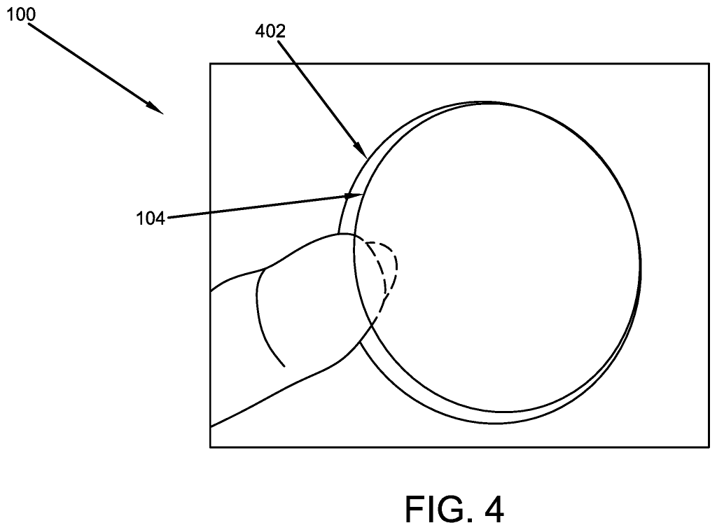

FIG. 4 illustrates the protective cover of the adhesive layer of the sticker being removed for use with a lens in accordance with the disclosed specification. As illustrated, a protective cover 402 protecting the rear surface 104 of the sticker or label 100 is removed to expose the adhesive material that is disposed on the rear surface 104. The rear surface 104 is then used for adhering the sticker or label 100 to the inside surface of a lens of an eyewear frame allowing correction of the vision issue of the wearer of the lens.

The adhesive layer 104 is also optically transparent and does not obstruct light rays passing through the sticker or label 100. Further, the sticker or label 100 does not cause any discoloration or leave any mark on the lens when removed from the lens. Any geometric shape, design, and configuration of the prescription sticker or label 100 is contemplated and falls within the scope of the invention without affecting the utility of the sticker. Further, the sticker can be designed as disposable or reusable.

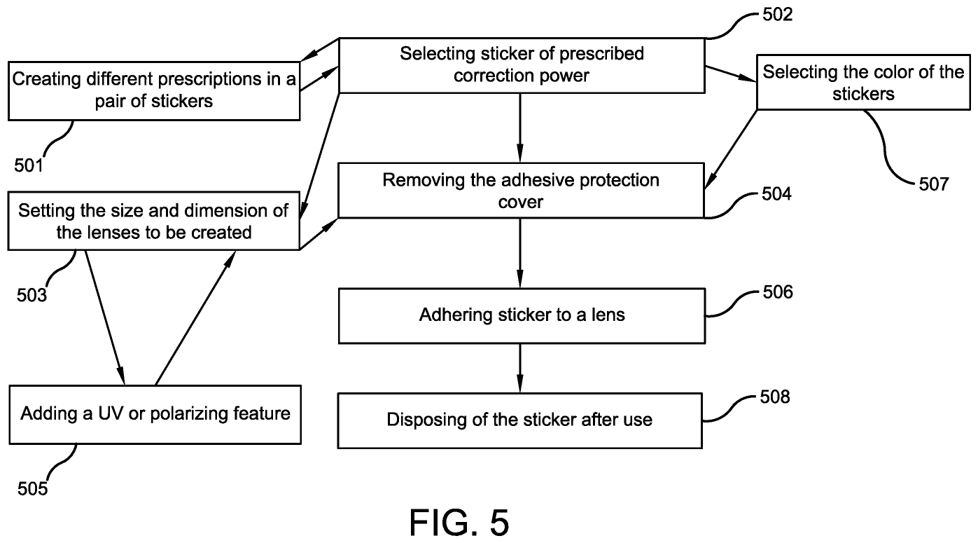

FIG. 5 illustrates a flow chart showing exemplary steps in using the prescription sticker 100 for correcting a vision defect in accordance with the disclosed specification. Initially, one or a pair of prescription stickers or labels of the present invention of a desired corrective power is selected by a user (Step 502). This step of selecting may include creating different lenses for each eye, such as a left and right lens at step 501. The user may then insert or select the sizes of the lenses for the frames the stickers or labels are to be used with at step 503. A user may further select any tint or color to match the original lens color, such as if ordering the corrective stickers for use with sunglasses at step 507. Also, at step 505 the user may add other protection such as UV protection or polarizing material to the order. Then, the adhesive protection cover of the stickers are removed for exposing the rear surface of the stickers (Step 504). Thereafter, the stickers are adhered to the inside surface of the sunglass lenses to correct vision defects (Step 506). After use, the stickers are disposed of as per preferences of wearer (Step 508). It is also contemplated that the stickers can be applied on the lower portion of a wearer's sunglasses so that the wearer can read at the beach, similar to a bifocal.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “transparent prescription sticker or label”, “disposable prescription sticker or label”, “prescription sticker”, “sticker or label”, and “vision correction sticker” are interchangeable and refer to the disposable prescription sticker or label 100 of the present invention for sunglasses.

Notwithstanding the foregoing, the disposable prescription sticker 100 of the present invention can be of any suitable size and configuration as is known in the art without affecting the overall concept of the invention, provided that it accomplishes the above-stated objectives. One of ordinary skill in the art will appreciate that the disposable prescription sticker or label 100 as shown in the FIGS. are for illustrative purposes only, and that many other sizes and shapes of the disposable prescription sticker or label 100 are well within the scope of the present disclosure. Although the dimensions of the disposable prescription sticker or label 100 are important design parameters for user convenience, the disposable prescription sticker or label 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vision correction sticker comprising:
an optically transparent film having a front surface and a rear surface;
an adhesive layer positioned on the rear surface; and
a protective covering provided over the adhesive layer, wherein the front surface of the optically transparent film faces an eye of a user and the optically transparent film is sized and configured to correct a vision defect.

2. The vision correction sticker as provided in claim 1, wherein the optically transparent film comprises thickness of between 0.005 inches and 0.05 inches.

3. The vision correction sticker as provided in claim 1, wherein the optically transparent film is further comprised of a tint, a color, a UV film, a polarizing film or a combination thereof.

4. The vision correction sticker as provided in claim 1, wherein the vision correction ticker is provided as part of a sheet.

5. The vision correction sticker as provided in claim 1, wherein the protective covering comprises a silicone layer.

6. The vision correction sticker as provided in claim 1, wherein the adhesive layer comprises a select one of a removable adhesive, a repositionable adhesive or an activatable adhesive.

7. The vision correction sticker as provided in claim 1, wherein the optically transparent film is sized and configured to cover an eyeglass lens.

8. The vision correction sticker as provided in claim 1, wherein the protective covering substantially covers the rear surface and the adhesive layer.

9. The vision correction sticker as provided in claim 1, wherein the optically transparent film is a PETG (Polyethylene Terephthalate Glycol) film or another polyethylene film.

10. The vision correction sticker as provided in claim 1, wherein the adhesive layer comprises an optically clear adhesive and an acrylic adhesive.

11. A package of vision correction labels comprising:
a package;
a sheet contained within the package, wherein the sheet is comprised of an optically transparent film;
a plurality of vision correction labels positioned on the sheet, wherein each of the plurality of vision correction labels comprises a front surface and a rear surface; and
a vision correction prescription represented by teach of the plurality of vision correction labels.

12. The package of vision correction labels as recited in claim 11, wherein the rear surface comprises an adhesive coating.

13. The package of vision correction labels as recited in claim 12, wherein the adhesive coating is an acrylic adhesive and is optically clear.

14. The package of vision correction labels as recited in claim 12 further comprising a protective covering, wherein the protective covering comprises a silicone release material and substantially covers the adhesive coating and the rear surface.

15. The package of vision correction labels as recited in claim 11, wherein the sheet comprises a thickness of between 0.005 inches and 0.05 inches.

16. The package of vision correction labels as recited in claim 11, wherein the sheet further comprises a tint, a color, a UV film, a polarizing film or a combination thereof.

17. The package of vision correction labels as recited in claim 11, wherein the optically transparent film is a PETG (Polyethylene Terephthalate Glycol) film or other polyethylene film.

18. The package of vision correction labels as recited in claim 11, wherein the package comprises a plurality of sheets and each of the plurality of sheets includes an indicia relating to a time and a date of manufacture.

19. A method of vision correction, the method comprising the steps of:
selecting a sticker having a vision correction prescription;
adding at least one of a tint, a color, a UV film, a polarizing film or a combination thereof to the sticker;
removing a protective layer from the sticker to expose an adhesive; and
adhering the vision correction sticker to a lens of an eyewear frame.

20. The method as recited in claim 19 further comprising a step of creating a different vison correction prescription after the step of selecting a sticker.
